(19) United States
(12) Patent Application Publication
(10) Pub. No.: US 2026/0190169 A1
(43) Pub. Date: Jul. 2, 2026

(54) COMMUNICATION APPARATUS, METHOD, AND STORAGE MEDIUM STORING PROGRAM

(71) Applicant: CANON KABUSHIKI KAISHA, Tokyo (JP)

(72) Inventor: SHINICHI ICHIMURA, Kanagawa (JP)

(21) Appl. No.: 19/426,488

(22) Filed: Dec. 19, 2025

(30) Foreign Application Priority Data
Dec. 27, 2024 (JP) 2024-233112

(51) Int. Cl. H04W 76/15; H04W 84/12

(52) U.S. Cl. CPC H04W 76/15; H04W 84/12

(57) ABSTRACT

A communication apparatus includes: a first communication unit that performs communication via an external access point through wireless LAN communication; a second communication unit that performs communication directly with an external terminal device through wireless LAN communication, without going through the external access point; and a control unit that performs control such that, in a state where a connection has been established by the second communication unit with the external terminal device, when a connection is to be established by the first communication unit with the external access point in which communication through a first communication method performed via a plurality of external access points is enabled, specific processing for terminating the connection established by the second communication unit with the external terminal device is performed.

### BACKGROUND

### Field of the Technology

The present disclosure relates to a communication apparatus capable of executing wireless communication, a method executed by the communication apparatus, and a storage medium that stores a program.

### Description of the Related Art

With the increase in the amount of data communication in recent years, the development of communication technologies such as wireless Local Area Network (LAN) and the like is progressing. The IEEE 802.11 standard series is known as a major wireless LAN communication standard. The IEEE 802.11 standard series includes standards such as IEEE 802.11a/b/g/n/ac/ax/be.

Japanese Patent Laid-Open No. 2018-50133 discloses a communication apparatus compliant with IEEE 802.11a/b/g/n/ac/ax. A system for multi-AP communication, in which multiple access points (APs) cooperate to transmit data to a station (STA), is also under consideration.

### SUMMARY

Multi-AP communication has room for improvement in terms of the appropriateness of communication and usability. The present disclosure provides a system for performing communication more appropriately in a predetermined communication method.

A communication apparatus according to the present disclosure is a communication apparatus comprising: at least one memory and at least one processor which function as: a first communication unit configured to perform communication via an external access point through wireless LAN communication; a second communication unit configured to perform communication directly with an external terminal device through wireless LAN communication, without going through the external access point; and a control unit configured to perform control such that, in a state where a connection has been established by the second communication unit with the external terminal device, when a connection is to be established by the first communication unit with the external access point in which communication through a first communication method performed via a plurality of external access points is enabled, specific processing for terminating the connection established by the second communication unit with the external terminal device is performed.

According to the present disclosure, communication can be performed more appropriately in a predetermined communication method.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating the configuration of a wireless communication system.

FIGS. 2A and 2B are diagrams illustrating the configuration of a communication apparatus.

FIGS. 3A to 3D are diagrams illustrating user interface screens.

FIGS. 4A and 4B are diagrams illustrating the configuration of a mobile terminal device.

FIG. 5 is a diagram illustrating the configuration of an access point.

FIG. 6 is a sequence chart illustrating a sequence involved in multi-AP communication performed between an STA and an AP.

FIG. 7 is a sequence chart illustrating communication between a communication apparatus and an access point.

FIG. 8 is a diagram illustrating a hidden node problem.

FIG. 9 is a sequence chart illustrating communication between a communication apparatus and an access point.

FIG. 10 is a diagram illustrating a user interface screen.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

### System Configuration

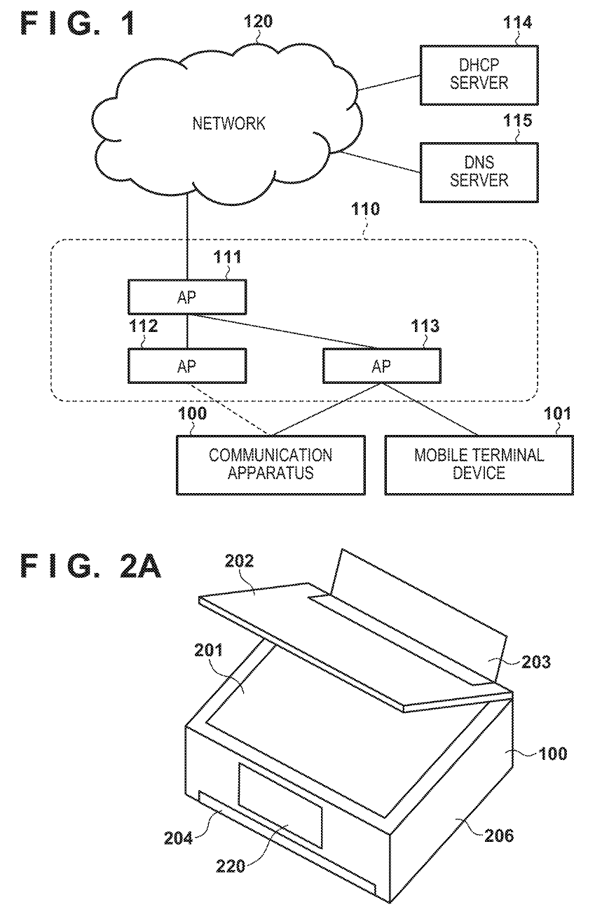

FIG. 1 illustrates an example of the configuration of a system according to the present embodiment. In one example, this system is a wireless communication system in which a plurality of communication apparatuses can perform communication with each other wirelessly. The system illustrated in FIG. 1 includes an MFP 100 serving as a communication apparatus, a mobile terminal device 101, a multi-AP group 110 including a plurality of access points (APs), a DHCP server 114, a DNS server 115, and a network 120. Although the multi-AP group 110 will be described as including an AP 111, an AP 112, and an AP 113, the multi-AP group 110 may include more APs than these.

The mobile terminal device 101 is a device having a wireless communication function that uses wireless LAN or the like. “Wireless LAN” may be called “WLAN” hereinafter. The mobile terminal device 101 may be a personal information terminal such as a Personal Digital Assistant (PDA), a mobile telephone terminal (a smartphone), a tablet terminal, a digital camera, a personal computer, or the like.

The MFP 100 is a printing device having a printing function, and may further have a reading function (a scanner), a fax function, a telephone function, and the like. The MFP 100 according to the present embodiment also has a communication function that enables wireless communication with the mobile terminal device 101. Although the present embodiment describes a case where the MFP 100 is used as an example, the configuration is not limited thereto. For example, a scanner device, a projector, a mobile terminal, a smartphone, a laptop PC, a tablet terminal, a PDA, a digital camera, a music playback device, a television, a smart speaker, or the like, which has a communication function, may be used instead of the MFP 100. Note that “MFP” is an acronym for “Multi-Function Peripheral”.

The AP 111 is provided separate from (outside) the mobile terminal device 101 and the MFP 100, and functions as a WLAN base station device. A communication apparatus having a WLAN communication function can perform communication in WLAN infrastructure mode via the AP 111. Infrastructure mode may also be called “wireless infrastructure mode”. The AP 111 communicates wirelessly with a communication apparatus that has permitted (authenticated) a connection to the AP 111 itself, and relays wireless communication between that communication apparatus and other communication apparatuses. The AP 111 can, for example, be connected to a wired communication network, and can relay communication between a communication apparatus connected to that wired communication network and another communication apparatus wirelessly connected to the AP 111.

The APs 112 and 113 have the same hardware configurations as the AP 111. The AP 111, the AP 112, and the AP 113 are APs that support multi-AP communication (described later), and that form a group (the multi-AP group 110) and operate in cooperation with each other.

The DHCP server 114 connects to the MFP 100 via the AP 111 and the network 120, and provides services to the MFP 100 by responding to requests from the MFP 100. Although FIG. 1 illustrates a configuration in which the DHCP server 114 is connected as a device separate from the AP 111, the AP 112, and the AP 113, the configuration may be such that the AP 111, the AP 112, and the AP 113 have DHCP server functionality.

The DNS server 115 is connected to the MFP 100, the mobile terminal device 101, and the like via the AP 111 and the network 120, and provides services for name resolution by responding to requests from the MFP 100, the mobile terminal device 101, and the like. Here, the network 120 may be the Internet, or may be a private network in a business, a mobile phone network, or the like.

### External Configuration of MFP

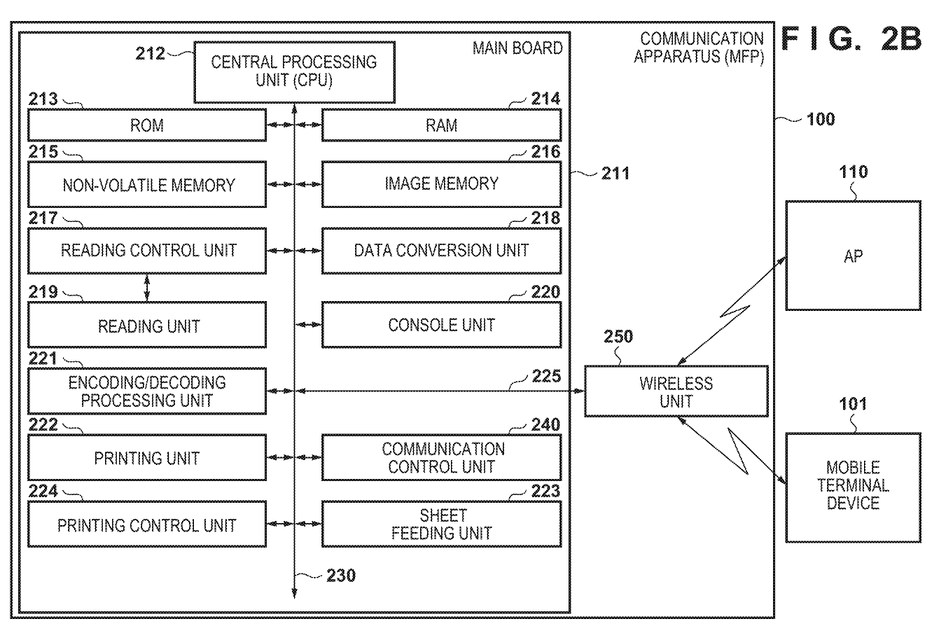

FIG. 2A illustrates an example of the external configuration of the MFP 100. The MFP 100 includes a document platform 201, a document cover 202, a printing paper insertion port 203, a printing paper discharge port 204, and a console unit 220, for example. The document platform 201 is a platform for placing a document to be read. The document cover 202 is a cover for securing a document placed on the document platform 201, and for ensuring that light from a light source that illuminates the document does not escape to the exterior when the document is being read (scanned). The printing paper insertion port 203 is an insertion port in which various sizes of sheets can be set. The printing paper discharge port 204 is a discharge port for discharging a sheet which has been printed onto. Paper set in the printing paper insertion port 203 is conveyed one sheet at a time to a printing unit, where the sheet is printed onto and then discharged from the printing paper discharge port 204. The console unit 220 is configured including a touchscreen, and is configured such that a user can launch various functions as an MFP, make various settings, and the like. The console unit 220 may also be configured including physical operation keys such as text input keys, a cursor key, an OK key, a cancel key, and the like, as well as LEDs, an LCD, and the like.

The MFP 100 has a WLAN wireless communication function and therefore is configured also including a wireless communication antenna 206 for that wireless communication, although the antenna 206 is not necessarily visible from the exterior. Like the mobile terminal device 101, the MFP 100 can communicate wirelessly over a WLAN.

### MFP Configuration

FIG. 2B illustrates an example of the configuration of the MFP 100. The MFP 100 is configured including a main board 211 that performs main control of the device itself, and a wireless unit 250, which is a single communication module that performs WLAN communication using at least one antenna. The MFP 100 may also be configured including a wired LAN unit for wired LAN communication, for example.

The main board 211 is configured including, for example, a CPU 212 (a central processing unit), a ROM 213, a RAM 214, a non-volatile memory 215, an image memory 216, a reading control unit 217, a data conversion unit 218, a reading unit 219, and an encoding/decoding processing unit 221. The main board 211 also includes, for example, a printing unit 222, a sheet feeding unit 223, a printing control unit 224, and the console unit 220. The function units in the main board 211 are connected to each other by a system bus 230 managed by the CPU 212. Additionally, the main board 211 and the wireless unit 250 are connected, for example, by a dedicated bus 225.

The CPU 212 is a system control unit including at least one processor, and controls the MFP 100 as a whole. The processing by the MFP 100 described below is implemented by the CPU 212 executing programs stored in the ROM 213, for example. Note that dedicated hardware for each process may be provided. The ROM 213 is a non-volatile memory that stores control programs executed by the CPU 212, embedded OS programs, and the like. In the present embodiment, the CPU 212 performs software control such as scheduling, task switching, and the like by loading each control program stored in the ROM 213 into the RAM 214 and executing the program under the management of an embedded OS, which is also stored in the ROM 213.

The RAM 214 is a volatile memory constituted by an SRAM or the like. The RAM 214 stores data such as program control variables, data such as setting values registered by the user and management data of the MFP 100, and the like. In addition, the RAM 214 can be used as various types of working buffers. The non-volatile memory 215 is constituted by a memory such as a flash memory, for example, and continues to store data even when the MFP 100 is turned off. The image memory 216 is constituted by a memory such as a DRAM. The image memory 216 stores image data received through the wireless unit 250, image data processed by the encoding/decoding processing unit 221, and the like. Note that the memory configuration of the MFP 100 is not limited to the configuration described above. The data conversion unit 218 analyzes data in various formats, converts image data into print data, and the like.

The reading control unit 217 controls the reading unit 219 (e.g., a contact-type image sensor (CIS)) to optically read (scan) a document placed on the document platform 201. The reading control unit 217 converts an image obtained by optically reading the document into electrical image data (an image signal) and outputs the image data. At this time, the reading control unit 217 may perform various types of image processing, such as binarization, half-tone processing, and the like before outputting the image data.

The console unit 220 includes a touchscreen that displays images based on display control by the CPU 212, and generates signals in response to accepting user operations made through the touchscreen, physical operation keys, and the like.

The encoding/decoding processing unit 221 performs encoding processing, decoding processing, scaling processing, and the like on image data handled by the MFP 100 (JPEG, PNG, and the like).

The sheet feeding unit 223 holds sheets for printing. The sheet feeding unit 223 can supply sheets set therein under the control of the printing control unit 224. The sheet feeding unit 223 may include a plurality of sheet feeding units to hold a plurality of types of sheets in a single apparatus, and from which sheet feeding unit sheets are fed can be controlled under the control of the printing control unit 224.

The printing control unit 224 applies various types of image processing, such as smoothing processing, print darkness correction processing, color correction, and the like, to the image data to be printed, and outputs the processed image data to the printing unit 222. The printing unit 222 is configured to be capable of executing ink jet printing processing, for example, so that ink supplied from an ink tank is ejected from a print head and an image is printed on a printing medium such as paper. Note that the printing unit 222 may be configured to be capable of executing other types of printing processing, such as electrophotographic printing. The printing control unit 224 can also periodically read out information on the printing unit 222 and update status information and the like stored in the RAM 214, including the amount of ink remaining in the ink tank, the state of the print head, and the like.

The wireless unit 250 is a unit capable of providing a WLAN communication function, and is capable of providing functions similar to those of a wireless unit 401 of the mobile terminal device 101, for example. In other words, according to the WLAN standard, the wireless unit 250 converts data into packets and transmits the packets to other devices, and also restores packets from other external devices into the original data thereof and outputs the data to the CPU 212.

The wireless unit 250 is capable of performing communication as a station (“STA”, hereinafter) or an access point (AP) compliant with the IEEE 802.11 standard series. Specifically, communication compliant with the IEEE 802.11a/b/g/n/ac/ax/be/bn standards can be performed. The wireless unit 250 includes at least one processor and at least one memory in which programs are stored.

A communication control unit 240 is a unit that controls the communication functions of the MFP 100, and controls the wireless unit 250. The processing by the communication control unit 240 is realized by the CPU 212 executing a control program stored in the ROM 213. The communication control unit 240 and the wireless unit 250 are connected to each other by the system bus 230 and the dedicated bus 225, for example.

### MFP Console Unit

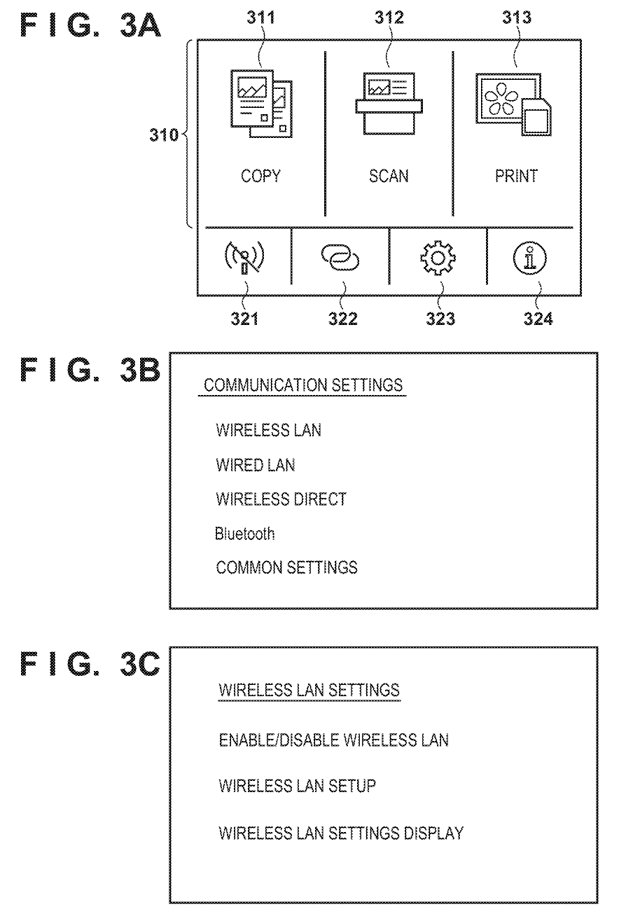

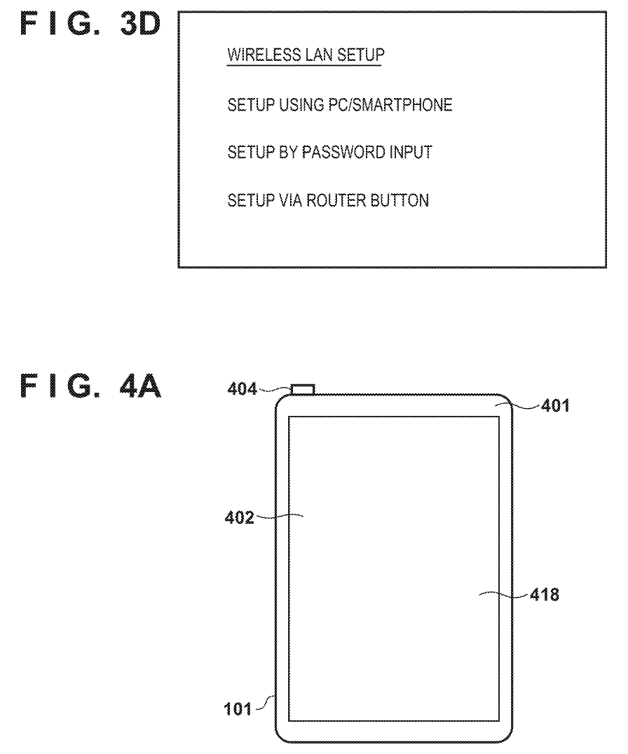

FIGS. 3A to 3D schematically illustrate examples of screens displayed in a display (a touchscreen) included in the console unit 220 of the MFP 100.

FIG. 3A illustrates an example of a home screen displayed when the MFP 100 is turned on and operations such as printing, scanning, or the like are not underway (an “idle state” or a “standby state”). A region 310 at the top of the home screen is a basic menu region, where menu items selected when instructing copying or scanning are displayed. In FIG. 3A, icons 311 to 313 corresponding to copying, scanning, and printing are listed as menu items (display items) in the basic menu in the region 310. When each menu item in the basic menu is selected, a corresponding detailed menu is displayed, and the MFP 100 can be caused to execute operations/functions (copying, scanning, or the like) corresponding to the selected menu item. A menu item different from the icons 311 to 313 can be displayed in the region 310 through an operation for displaying another page in the basic menu (an operation for sliding to the left or right in the region 310 or the like). For example, an icon corresponding to the cloud can be displayed. “Cloud” is a menu item related to a cloud function that uses Internet communication.

A network display region 321 is a region that displays an icon indicating the state of the network. In the example illustrated, an icon indicating that both wireless infrastructure and wireless direct are disabled is displayed in the network display region 321. Additionally, a communication settings menu can be displayed by touching the network display region 321.

An icon 322 is an operation icon that accepts an instruction to perform setup using a PC or a smartphone. When the icon 322 is touched, the same operations are performed as when “Set Up Using PC/Smartphone” is selected in FIG. 3D (described later).

An icon 323 is an operation icon selected when changing the settings of the MFP 100 or performing maintenance.

FIG. 3B is an example of the display of a menu screen for the communication settings displayed when the network display region 321 is touched in the home screen illustrated in FIG. 3A. “Wireless LAN”, “Wired LAN”, “Wireless Direct”, “Bluetooth”, and “Common Settings” are displayed as menu items (options) in the communication settings menu screen. “Wireless LAN”, “Wired LAN”, and “Wireless Direct” are menu items for LAN settings, and settings such as wired connection settings, settings for enabling and disabling wireless infrastructure mode, settings for enabling and disabling a P2P mode such as WFD and software AP mode, and the like can be set using these items.

FIG. 3C is an example of the display of a menu screen for the wireless LAN settings, displayed when the “Wireless LAN” item has been selected in the screen illustrated in FIG. 3B. “Enable/Disable Wireless LAN”, “Wireless LAN Setup”, and “Wireless LAN Settings Display” are displayed as menu items (options) in the wireless LAN settings menu screen. The settings for enabling/disabling wireless infrastructure mode can be switched by selecting the “Enable/Disable Wireless LAN” item. When the “Wireless LAN Setup” item is selected, the wireless LAN setup menu in FIG. 3D is displayed. When “Display Wireless LAN Settings” is selected, a detailed screen displaying details such as the current wireless LAN settings and communication status (the wireless LAN settings display screen) is displayed.

FIG. 3D is an example of the display of a menu screen for wireless LAN setup, displayed when the “Wireless LAN Setup” item has been selected in the screen illustrated in FIG. 3C. “Set Up Using PC/Smartphone”, “Set Up by Entering Password”, and “Set Up Using Router Button” are displayed as menu items (options) in the wireless LAN setup menu screen. Wireless LAN setup such as setup using network setup mode (described later), setup by entering a password, setup using a pushbutton method, or the like can be performed using these items.

### External Configuration of Mobile Terminal Device

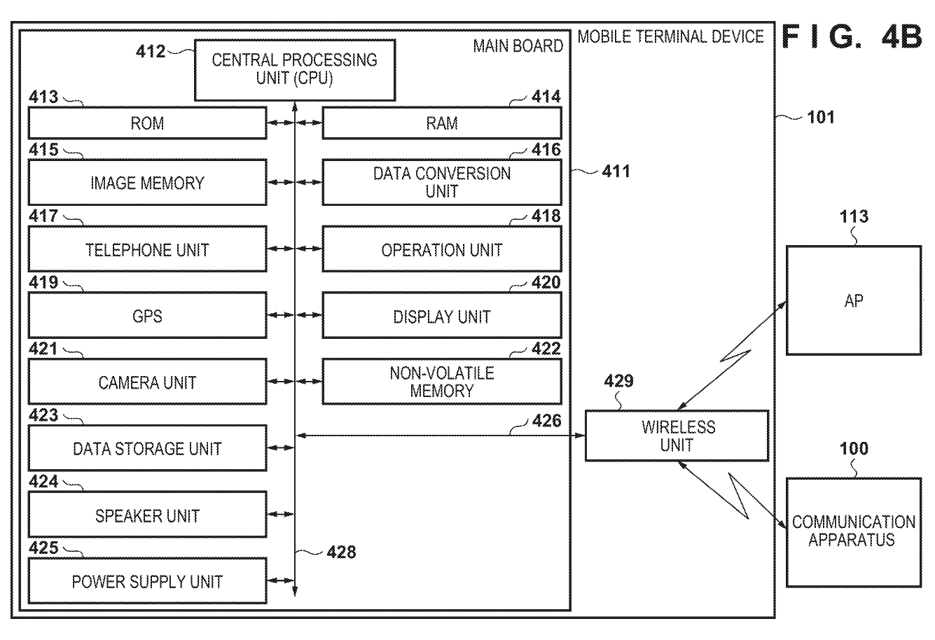

FIG. 4A is a diagram illustrating an example of the external configuration of the mobile terminal device 101. The present embodiment will describe a case where the mobile terminal device 101 is a typical smartphone, for example. Note that the mobile terminal device 101 is configured including a display unit 420, an operation unit 418, and a power key 404, for example. The display unit 420 is a display having an organic electroluminescence (EL)-based display mechanism or a Liquid Crystal Display (LCD)-based display mechanism, for example. Note that the display unit 420 may display information using a Light Emitting Diode (LED) or the like, for example. The mobile terminal device 101 may also have a function for outputting information by audio in addition to or instead of the display unit 420. The operation unit 418 is configured including physical keys such as keys, buttons, and the like, a touch panel, and the like for detecting user operations. Note that in this example, the information display in the display unit 420 and the acceptance of user operations by the operation unit 418 are performed using a common touchscreen, and thus the display unit 420 and the operation unit 418 are implemented as a single device. In this case, for example, button icons or a software keyboard are displayed using a display function of the display unit 420, and the user touching those locations is detected using an operation reception function of the operation unit 418. Note that the display unit 420 and the operation unit 418 may be separate, and the hardware for display and the hardware for accepting operations may be provided individually. The power key 404 is a physical key for accepting user operations for turning the mobile terminal device 101 on or off.

The mobile terminal device 101 includes the wireless unit 401, which provides WLAN communication functionality, but is not necessarily visible from the exterior. The wireless unit 401 is configured to be capable of data (packet) communication in a WLAN system compliant with the IEEE 802.11 standard series (IEEE 802.11a/b/g/n/ac/ax/be/bn), for example. However, the configuration is not limited thereto, and the wireless unit 401 may be capable of communication in a WLAN system compliant with another standard. This example assumes that the wireless unit 401 is capable of performing communication in both the 2.4 GHz and 5 GHz frequency bands. However, the wireless unit 401 is not limited thereto, and may be capable of performing communication in one or more frequency bands including the 2.4 GHz band, the 5 GHz band, and the 6 GHz band. The wireless unit 401 is also assumed to be capable of communication based on WFD, communication using software AP mode, communication using wireless infrastructure mode, and the like. Operations performed in these modes will be described later.

### Configuration of Mobile Terminal Device

FIG. 4B illustrates an example of the configuration of the mobile terminal device 101. The mobile terminal device 101 includes a main board 411 that performs main control of the device itself, and a wireless unit 429 that performs WLAN communication, for example. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym of “Central Processing Unit”, ROM is an acronym of “Read Only Memory”, RAM is an acronym of “Random Access Memory”, and GPS is an acronym of “Global Positioning System”. The mobile terminal device 101 also includes the display unit 420 and the operation unit 418. The function units in the main board 411 are connected to each other by a system bus 428 managed by the CPU 412. Additionally, the main board 411 and the wireless unit 429 (the wireless unit 401 mentioned earlier) are connected, for example, by a dedicated bus 426.

The CPU 412 is a system control unit including at least one processor, and controls the mobile terminal device 101 as a whole. The processing by the mobile terminal device 101 described below is implemented by the CPU 412 executing programs stored in the ROM 413, for example. Note that dedicated hardware for each process may be provided. The ROM 413 stores control programs executed by the CPU 412, embedded operating system (OS) programs, and the like. In the present embodiment, the CPU 412 performs software control such as scheduling, task switching, and the like by executing each control program stored in the ROM 413 under the management of an embedded OS, which is also stored in the ROM 413.

The RAM 414 is constituted by a Static RAM (SRAM) or the like. The RAM 414 stores data such as program control variables, data such as setting values registered by the user and management data of the mobile terminal device 101, and the like. In addition, the RAM 414 can be used as various types of working buffers. The image memory 415 is constituted by a memory such as a Dynamic RAM (DRAM) or the like. The image memory 415 temporarily stores image data received through the wireless unit 429, image data read out from the data storage unit 423, and the like for processing by the CPU 412. The non-volatile memory 422 is constituted by a memory such as a flash memory, for example, and continues to store data even when the mobile terminal device 101 is turned off. Note that the memory configuration of the mobile terminal device 101 is not limited to the configuration described above. For example, the image memory 415 and the RAM 414 may be implemented by the same memory, data may be backed up using the data storage unit 423, or the like. Additionally, although the present embodiment describes a DRAM as an example of the image memory 415, another storage medium such as a hard disk, a non-volatile memory, or the like may be used instead.

The data conversion unit 416 analyzes data in various formats, performs data conversion such as color conversion and image conversion, and the like. The telephone unit 417 controls a telephone line, and implements telephone communication by processing audio data input and output through the speaker unit 424. The GPS 419 receives radio waves transmitted from a satellite and obtains location information such as the current latitude, longitude, and the like of the mobile terminal device 101.

The camera unit 421 has a function for electronically recording and encoding an image input through a lens. The image data captured by the camera unit 421 is stored in the data storage unit 423. The speaker unit 424 performs control for implementing a function for inputting or outputting audio for the telephone function, other functions such as alarm notifications, and the like. The power supply unit 425 is a portable battery, for example, and controls the supply of power to the interior of the device. Power states include, for example, a “battery depleted state” in which there is no power remaining in the battery, a “power off state” in which the power key 404 has not been pressed, an “operating state” in which the battery is running normally, and a “power-saving state” in which the battery is operating but is in a power saving state.

The display unit 420 enables various types of input operations to be made, displays the operating state and status of the MFP 100, and the like under the control of the CPU 412. In response to user operations being accepted, the operation unit 418 performs control such as generating electrical signals corresponding to those operations and outputting the electrical signals to the CPU 412.

The mobile terminal device 101 performs wireless communication using the wireless unit 429, and performs data communication with other devices such as the MFP 100. The wireless unit 429 converts data into packets and transmits the packets to other devices. The wireless unit 429 also restores packets from other external devices into the original data and outputs the data to the CPU 412. The wireless unit 429 is a unit for implementing communication compliant with each WLAN standard. The wireless unit 429 can operate in at least two communication modes simultaneously, including wireless infrastructure mode and P2P (WLAN) mode. Note that the frequency bands used in these communication modes can be limited by the functions and performance of the hardware.

### Configuration of Access Point

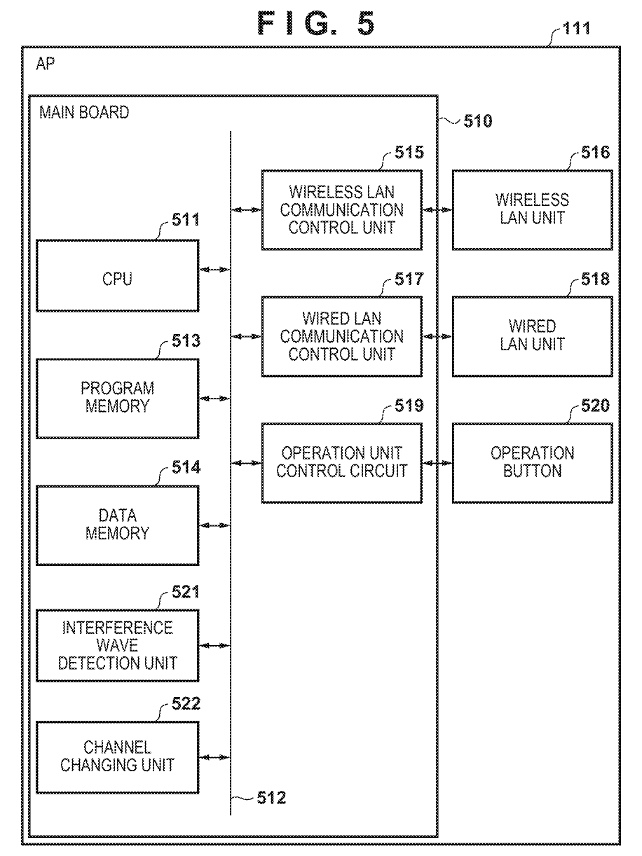

FIG. 5 is a block diagram illustrating the configuration of the AP 111 having a wireless LAN access point function. A main board 510, which controls the AP 111, is configured including a wireless LAN unit 516, a wired LAN unit 518, and an operation button 520.

A microprocessor-type CPU 511 disposed on the main board 510 operates in accordance with a control program stored in a ROM-type program memory 513 and data in a RAM-type data memory 514, which are connected to the CPU 511 by an internal bus 512. The CPU 511 performs communication with other communication terminal devices over a wireless LAN by controlling the wireless LAN unit 516 through a wireless LAN communication control unit 515. Specifically, the wireless LAN unit 516 is configured to be capable of data (packet) communication in a WLAN system compliant with the IEEE 802.11 standard series (IEEE 802.11a/b/g/n/ac/ax/be/bn), for example, as wireless LAN communication. The wireless LAN unit 516 is also capable of performing communication as an AP that supports multi-AP communication (described later). However, the configuration is not limited thereto, and the wireless LAN unit 516 may be capable of communication in a WLAN system compliant with another standard. This example assumes that the wireless LAN unit 516 is capable of performing communication in the 2.4 GHz, 5 GHz, and 6 GHz frequency bands. However, the wireless LAN unit 516 is not limited thereto, and may be capable of performing communication in one or more frequency bands including the 2.4 GHz band, the 5 GHz band, and the 6 GHz band.

The CPU 511 also performs communication with other communication apparatuses over a wired LAN by controlling the wired LAN unit 518 through a wired LAN communication control unit 517. The CPU 511 is capable of accepting operations made by a user manipulating the operation button 520, by controlling an operation unit control circuit 519. The CPU 511 includes at least one processor.

The AP 111 also includes an interference wave detection unit 521 and a channel changing unit 522. The interference wave detection unit 521 performs interference wave detection processing when communicating wirelessly in a band in which Dynamic Frequency Selection (DFS) is implemented. When communicating wirelessly in a band in which DFS is implemented, the channel changing unit 522 performs processing for changing the channel used when interference waves are detected, when it is necessary to immediately change to a free channel, and the like.

Note that the APs 112 and 113 have the same configurations as the AP 111.

### P2P Mode (Direct Mode)

An overview of a P2P (WLAN) communication method for devices to wirelessly communicate directly with each other without traversing an external access point in WLAN communication will be given next. P2P (WLAN) communication can be implemented through a plurality of methods, e.g., the communication apparatus can support a plurality of modes for P2P (WLAN) communication and selectively execute P2P communication (WLAN) using one of the plurality of modes.

The following two modes are assumed as P2P modes.

Software AP Mode

Wi-Fi Direct (WFD) Mode

A communication apparatus capable of P2P communication can be configured to support at least one of these modes. However, even a communication apparatus capable of P2P communication does not have to support all of these modes, and may be configured to support only some.

In a communication apparatus having a WFD communication function (e.g., the mobile terminal device 101), an application for implementing the communication function (in some cases, a dedicated application) is called in response to a user operation being accepted through the operation unit of the device. The communication apparatus can then display a screen of a user interface (UI) provided by the application to prompt the user to perform an operation, and then perform WFD communication on the basis of the user operation accepted in response thereto.

### Software AP Mode

In software AP mode, the communication apparatus (e.g., the mobile terminal device 101) operates in the role of a client requesting various types of services. The other communication apparatus (e.g., the MFP 100) operates as a software AP capable of performing WLAN AP functions through software settings. Note that commands, parameters, and the like sent and received when establishing a wireless connection between the client and the software AP may be any specified by the Wi-Fi (registered trademark) standard, and will therefore not be described. The MFP 100 operating in software AP mode also determines a frequency band and a frequency channel as a parent station. Accordingly, the MFP 100 can select which frequency band to use from 5 GHz and 2.4 GHz, as well as which frequency channel to use in that frequency band.

### WFD Mode

The MFP 100 may be started so as to be fixed as the parent station for WFD mode (Autonomous Group Owner). In this case, GO Negotiation processing for determining the role is unnecessary. Furthermore, in this case, the MFP 100 also determines the frequency band and the frequency channel to be used as the parent station. Accordingly, the MFP 100 can select which frequency band to use from 5 GHz and 2.4 GHz, as well as which frequency channel to use in that frequency band.

### Wireless Infrastructure Mode

In wireless infrastructure mode, communication apparatuses that perform communication with each other (e.g., the mobile terminal device 101 and the MFP 100) are connected to an external AP that manages the network (e.g., the AP 111), and the communication apparatuses perform communication with each other through the AP. In other words, communication between the communication apparatuses is executed over a network constructed by an external AP. The mobile terminal device 101 and the MFP 100 both discover the AP 111, and by transmitting a connection request and connecting to the AP 111, those communication apparatuses can perform communication in wireless infrastructure mode via the AP 111. Note that a plurality of communication apparatuses may be connected to individual separate APs. In this case, the communication apparatuses can perform communication by data being transferred among the APs. The commands, parameters, and the like sent and received during communication between the communication apparatuses via the access points may be any specified by the Wi-Fi standard, and will therefore not be described. In this case, the AP 111 also determines the frequency band and the frequency channel. Accordingly, the AP 111 can select which frequency band to use, from 5 GHz or 2.4 GHz and 6 GHz, as well as which frequency channel to use in that frequency band.

### Multi-AP Communication

In the IEEE 802.11be standard, Multi-Link communication is being standardized, in which, for example, a single access point (AP) establishes a plurality of links with a single station (STA) over a plurality of frequency channels, and communication is performed over those channels in parallel.

In addition, with the IEEE 802.11bn standard, which is the successor to the IEEE 802.11be standard, methods for improving usability using multi-AP communication are being considered.

A distributed multiple-input and multiple-output (MIMO) technique based on MIMO technology, in which a plurality of transmitting and receiving antennas are used in the same channel at the same time, can be given as an example. In distributed MIMO, in an environment where a plurality of APs and a plurality of STAs are present, groups are formed among the APs to share information about the communication state, the state of each AP, and the like, and data is sent from the plurality of APs to the STAs in parallel at the same timing. Joint transmission by the plurality of APs makes it possible to increase the number of spatial streams compared to when using a single AP, which is expected to improve throughput.

A technique in which a plurality of APs transmit data to an STA at different timings through time division, which improves the reception quality at the STA through the effects of time diversity and spatial diversity, can be given as another example.

A communication technique in which such a plurality of APs form a group and operate in cooperation with each other is called “multi-AP communication”, and the APs are classified into a single “Coordinator AP”, which manages all the APs, and “Coordinated APs”, which operate under the management of the Coordinator AP.

Hereinafter, in multi-AP communication, an AP that manages the other APs will be called a “Coordinator AP” or a “Sharing AP”. An AP that operates under the management of the Coordinator AP will be called a “Coordinated AP” or a “Shared AP”. The Coordinator AP and the Coordinated AP can exchange signals with each other. Each of the plurality of APs, including the APs 111 to 113, may be connected wirelessly to perform wireless LAN communication, or may be connected by wires to perform wired LAN communication. It is assumed that the APs 111 to 113 are capable of multi-AP communication in accordance with the IEEE 802.11 series standard, and support a configuration in which the plurality of APs operate in cooperation with each other to perform communication with a single common STA.

Multi-AP communication methods include Co-OFDMA and Joint-TX. Co-OFDMA, or Coordinated-Orthogonal Frequency Division Multiple Access, separates usable frequency resources among a plurality of Basic Service Sets (BSSs). For example, the frequency resources used by the AP 112 and the MFP 100 (STA) and the frequency resources used by the AP 113 and the MFP 100 (STA) do not overlap with each other. This makes it possible to prevent the communication from interfering among the BSSs. When an STA is capable of transmitting and receiving data simultaneously in a plurality of frequency bands (a plurality of resource units within the same channel or spanning different channels, a plurality of channels, a plurality of bands among the 2.4 GHz, 5 GHz, and 6 GHz bands), a plurality of APs can operate in cooperation with each other to transmit and receive data to and from the same STA. The “data” is image data, audio data, document data, print data, or the like, which are content data. In this case, for example, transmitting a packet 1 of content A from the AP 112 to the MFP 100 (STA) and transmitting a packet 2 of the content A from the AP 113 to the MFP 100 (STA) can be performed in parallel.

In Joint-TX, or Joint-Transmission, the same signal is transmitted and received between a plurality of APs and a single STA. In this case, the control is performed such that a multiplexed wave (a superimposed wave; a composite wave), which is composited such that radio waves output from the plurality of APs are amplified through wave interference, is received by the STA. As a result, control is performed such that the STA receives a signal that is stronger than the signal from a single AP alone (an amplified signal). For example, the signals between the AP 112 and the MFP 100 (the STA) and between the AP 113 and the MFP 100 (the STA) are multiplexed such that the same signal is amplified at the position of the MFP 100 (the STA). For example, at the same timing, the packet 1 of the content A is transmitted from the AP 112 to the MFP 100 (STA), and the packet 1 of the content A is transmitted from the AP 113 to the MFP 100 (STA). At that time, the radio waves of the content A are transmitted such that the radio waves of the content A are multiplexed at the position of the MFP 100 (STA). This makes it possible to improve the reliability (connectivity) of communication between the STA and the AP, as well as the speed at which data is transmitted and received.

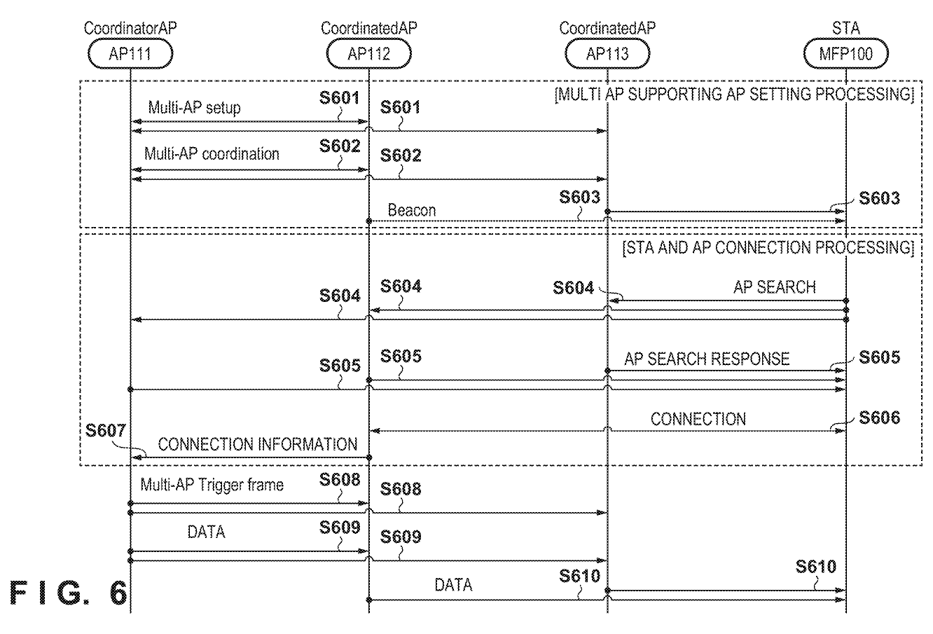

FIG. 6 is a sequence chart illustrating an example of processing in which the AP 111 operates as the Coordinator AP, and the AP 112 and the AP 113, which are Coordinated APs, operate in cooperation with each other to transmit and receive data to and from the MFP 100 (the STA). Processing executed by each device in this sequence is implemented by the CPU of each device reading out various programs stored in a memory provided in that device, such as a ROM or the like, into a RAM and executing those programs.

In step S601, the APs 111 to 113 perform multi-AP setup processing. In the multi-AP setup processing, capability information and parameters are exchanged among the APs, and a group for performing the multi-AP communication is formed.

In step S602, multi-AP coordination processing is performed among the APs 111 to 113. For example, the multi-AP communication method is determined, the roles of the APs (Coordinator AP or Coordinated AP) are determined, parameters and network information are exchanged among the APs, and the like. The multi-AP communication method and the roles of the APs are determined by exchanging and comparing parameters among the APs 111 to 113. At that time, the Coordinator AP (the AP 111) notifies the Coordinated APs (the AP 112 and the AP 113) of the network information to be used in common (the SSID to be used in common, the Basic Service Set color ID (BSSID) to be used in common, and the like). Note that the BSSID to be used in common is transmitted when using Joint-TX.

In step S603, the AP 112 and the AP 113 transmit a Beacon frame (information that the AP voluntarily transmits at regular intervals) in accordance with the network information transmitted in step S602. The Beacon frame includes information indicating that multi-AP communication can be performed the connected STA, information indicating the multi-AP communication method, and the like. A multi-AP Information Element (IE) may be added and transmitted within the Beacon frame transmitted by the APs supporting multi-AP communication. The multi-AP IE includes at least one of the following items of information (one or more of the following items of information):

SSIDs used by a plurality of Coordinated APs belonging to the same multi-AP group (ESSIDs to be used in common, as transmitted in step S602)

a BSSID (the BSSID to be used in common for APs belonging to multi-AP group 110, transmitted in step S602 when using Joint-TX)

a BSS color value (identifier) for multi-AP communication

an operational wireless channel (a communication channel to be used in common when using Joint-TX. A communication channel and/or resource unit used by the source AP, when using Co-OFDMA. A communication channel and/or resource unit used by other APs in the multi-AP group 110 may be included when using Co-OFDMA.)

the multi-AP communication method (information that specifies whether the method is Co-OFDMA or Joint-TX)

Note that the storage method and the configuration of these items of information are not limited thereto, and similar information may be stored and transmitted in a similar format. Note that the multi-AP IE may have another name, such as “multi-AP element”. Additionally, the multi-AP IE may be included in a wireless frame such as the device search response (Probe Response) frame used in step S605, other Action frames, or the like.

In step S604, the MFP 100 (the STA) starts establishing a connection with an AP using wireless infrastructure mode. The MFP 100 (the STA) starts searching for the AP by transmitting a device search request (Probe Request) frame to determine whether the AP supports multi-AP communication.

In step S605, the MFP 100 (the STA) searches out and discovers the AP by receiving a device search response (Probe Response) frame, which is a response to the AP search, a Beacon frame, or the like transmitted from the AP.

In step S606, the MFP 100 (the STA) performs connection processing with at least one Coordinated AP on the basis of information included in the frame received in step S605. Here, it is assumed that the MFP 100 (the STA) transmits a connection request to the AP 112 and executes a connection attempt (the connection processing). The connection processing here includes processing such as Authentication and Association specified in IEEE 802.11. The MFP 100 (the STA) may add a multi-AP IE to a transmitted Association Request frame to request multi-AP communication. Having received the Association Request frame, the AP 112 transmits an Association Response frame as a response thereto. As a result, a wireless LAN connection is established between the MFP 100 (STA) and the AP 112.

In step S607, when a connection has been established with the MFP 100 (the STA), the AP 112 notifies the Coordinator AP (the AP 111) of information indicating that a connected state has been established with the MFP 100 (the STA), as well as the connection parameters pertaining to the connected MFP 100 (the STA). The connection parameters pertaining to the connected MFP 100 (the STA) include information used in the connection processing between the AP 112 and the MFP 100 or generated during the connection processing (a PMK cache, information necessary for roaming, authentication information, and the like), an identifier of the STA, and the like. When the AP 113 and the MFP 100 (the STA) are connected, the AP 113 similarly notifies the Coordinator AP (the AP 111) that a connected state has been established.

After step S607, the connection parameters pertaining to the MFP 100 (STA) transmitted in step S607 are transmitted from the AP 111 to the AP 113. The AP 113 may perform processing to establish a connection with the MFP 100 using the transmitted connection parameters pertaining to the MFP 100 (the STA). However, when using Joint-TX, data can also be transmitted from APs that have not established a connection. In other words, an AP that has not established a connection can also be a source of multiplexed radio waves. As such, the processing for establishing the connection between the AP 113 and the MFP 100 need not be performed.

In step S608, the Coordinator AP (the AP 111) determines transmission parameters (information necessary for determining each Coordinated AP, the transmission timing and transmission output for each antenna, and/or resource unit allocation information, and the like) on the basis of the connection parameters of the Coordinated AP that is connected to the MFP 100 (the STA) (the parameters received in step S607), and subsequently allocates transmission data. The information of the determined transmission parameters is transmitted to each Coordinated AP by a multi-AP Trigger frame. The APs 112 and 113 set their own transmission parameters (transmission timing, transmission output, and resource units to be used) on the basis of the transmitted information. Note that the multi-AP Trigger frame may have another name. The multi-AP Trigger frame may also be an extension of the Trigger frame defined in the IEEE 802.11ax/be standard.

In step S609, the Coordinator AP (the AP 111) sends data to be transmitted to the MFP 100 (the STA) (e.g., content data such as image data, document data, print data, and the like) to the Coordinated APs.

In step S610, upon receiving the data to be transmitted from the Coordinator AP (the AP 111), the Coordinated APs (the APs 112 and 113) jointly send the data to be transmitted to the MFP 100. Upon receiving the data from the MFP 100 (the STA), the Coordinated APs (the AP 112 and the AP 113) send the received data to the Coordinator AP (the AP 111). Note that the order in which this data is transmitted and received is merely one example, and for example, the data from the STA may be received before the data is transmitted to the STA.

Note that the Coordinator AP may directly transmit and receive signals to and from the STA. For example, the AP 111 can operate as a Coordinator AP and a Coordinated AP. In this case, for example, the AP 111 may issue an instruction to the AP 112 or the AP 113 to cause the AP 112 or the AP 113 to exchange wireless frames with the STA while the AP 111 itself exchanges wireless frames with the STA. Note that the Coordinator AP can transmit the data to be transmitted to the Coordinated AP when the wireless frame is to be transmitted from the Coordinated AP. However, the configuration is not limited thereto, and the Coordinated AP may obtain data to be transmitted directly from the Internet, for example. The Coordinator AP may also receive data received by the Coordinated AP from the STA from a Coordinated AP, but the Coordinated AP may transfer the data received from the STA to a partner device of the STA without transferring the data to the Coordinator AP.

Note that any of the APs in the same network can operate as the Coordinator AP, and any one of the APs can be determined to operate as the Coordinator AP according to some criteria. Note that the Coordinator AP does not operate as an AP that transmits the Beacon frame, and may handle only the role of the Coordinator AP, such as sending instructions to each AP. Additionally, each AP may operate as a plurality of Coordinated APs by having a plurality of wireless LAN communication control units 515. The Coordinator AP may be implemented as a logical function, or a single physical AP may operate as a Coordinator AP while operating as one or more Coordinated APs.

The present embodiment assumes that the wireless unit 250 of the MFP 100 has only one antenna and analog front end. During a simultaneous connection in which both an infrastructure connection and a P2P connection are established in parallel, infrastructure mode, in which communication is performed over the infrastructure connection, and P2P mode, in which communication is performed over the P2P connection, are switched on a time-division basis for each unit of time. This switching is controlled by the CPU of the wireless unit 250 or the CPU 212. The setting value for the ratio (duty) between the communication on the infrastructure connection side and the communication on the P2P connection side is held in the ROM 213 in advance, and the CPU 212 performs the switch on the basis of the setting value. The setting value can be set by entering a command from outside the wireless unit 250. Note that the analog front end (AFE) is a circuit system that converts an analog signal from an antenna into a digital signal, and the quality and accuracy of the signal can be improved through amplifying, filtering, noise removal, and the like. The following descriptions assume that the wireless unit 250 of the MFP 100 has only one antenna and analog front end.

Furthermore, it is assumed that if the AP 111, the AP 112, and the AP 113 do not perform multi-AP communication, each AP manages only a specific BSS. For example, the AP 111 manages only a BSS 1, the AP 112 manages only a BSS 2, and the AP 113 manages only a BSS 3. For example, the AP 111 and the AP 112 each manage resource allocation and communication timing in OFDMA communication compliant with the IEEE 802.11ax standard in the BSS 1 and the BSS 2, respectively, and the AP 113 manages resource allocation and communication timing in OFDM communication in the BSS 3.

### Processing when Starting P2P Connection during Co-OFDMA Infrastructure Connection

Processing performed when starting a P2P connection during a Co-OFDMA infrastructure connection will be described next.

Consider a case where the MFP 100 connects to an external mobile terminal device (child station) as the parent station in a P2P connection when the MFP 100 is capable of multi-AP communication using Co-OFDMA as wireless communication in infrastructure mode. In other words, consider a case where an infrastructure connection and a P2P connection are established simultaneously in the MFP 100. In this case, the communication parameters on the infrastructure connection side need to match the communication parameters specified by the Coordinator AP, but the communication parameters will not necessarily be communication parameters that are easy to switch to wireless communication on the P2P connection side. As a result, the communication efficiency can drop significantly due to the switch between infrastructure mode and P2P mode.

In addition, in a Co-OFDMA system, during a designated time period designated as the transmission timing in a designated frequency band (RU) designated by the Coordinator AP, it is necessary for the MFP 100, which is the STA, to stand by for reception in the designated frequency band. In other words, it is necessary for the MFP 100 to occupy the designated frequency band designated by the Coordinator AP on the infrastructure connection side in the stated designated time period. In other words, in the designated time period, the MFP 100, which is the STA, cannot perform wireless communication on the P2P connection side in the designated frequency band even if data transmission/reception has not actually occurred on the infrastructure connection side, making it necessary to wait for data transmission/reception on the P2P connection side. This reduces the communication efficiency on the P2P connection side by that amount.

In the present embodiment, when wireless communication is performed on the P2P connection side, wireless communication is performed on the infrastructure connection side using a method other than Co-OFDMA. As described above, this makes it possible to suppress a significant drop in the communication efficiency between the wireless communication on the infrastructure connection side and the wireless communication on the P2P connection side. This processing is particularly effective in devices equipped with a wireless communication unit that has only one antenna and AFE used for wireless LAN communication, establishes an infrastructure connection and a P2P connection simultaneously, and switches between infrastructure mode and P2P mode through frequency time-division.

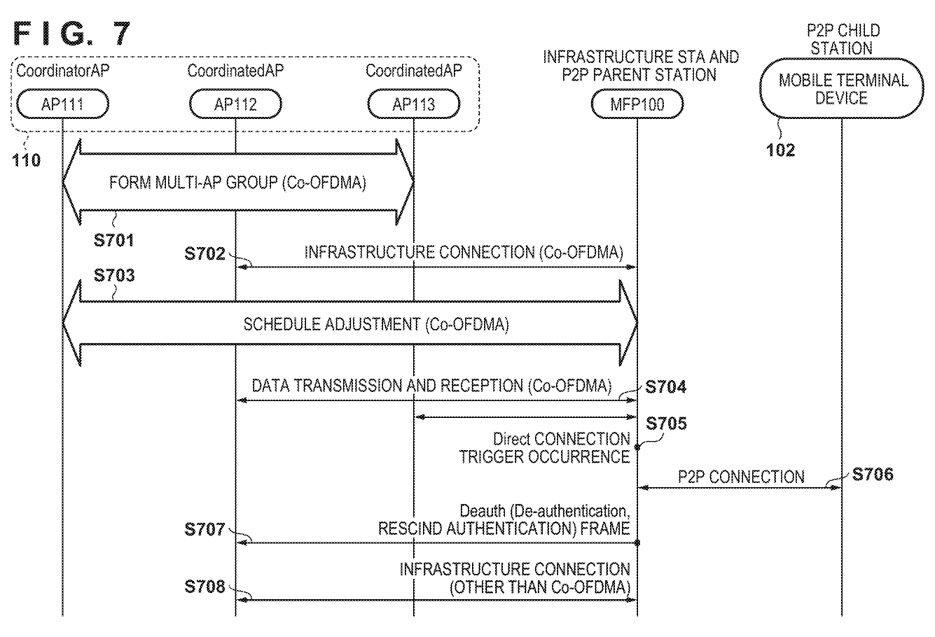

FIG. 7 is a diagram illustrating a sequence performed between devices when establishing a P2P connection in the MFP 100 from a state where an infrastructure connection has been established. The state where the infrastructure connection has been established is a state where the MFP 100 has established an infrastructure connection with the multi-AP group 110 in which multi-AP communication using Co-OFDMA has been enabled. The case where a P2P connection is established is a case where the MFP 100 establishes a wireless LAN P2P connection with a mobile terminal device 102 (not shown in FIG. 1). Processing executed by each device in this sequence is implemented by the CPU of each device reading out various programs stored in a computer-readable memory provided in that device, such as a ROM or the like, into a RAM and executing those programs. Here, the mobile terminal device 102 is a device that performs communication with the MFP 100 through a P2P connection, and is not a device that performs communication with the MFP 100 via an AP (over an infrastructure connection). As such, the mobile terminal device 102 is given a different reference sign, being a device different from the mobile terminal device 101 in FIG. 1, which is a device that performs communication with the MFP 100 via an AP (over an infrastructure connection). However, the configuration of the mobile terminal device 102 is assumed to be the same as that of the mobile terminal device 101 illustrated in FIGS. 4A and 4B.

In step S701, the AP 111, the AP 112, and the AP 113 form the multi-AP group 110 through Co-OFDMA. The processing performed in step S701 corresponds to the processing performed in steps S601 and S602 of FIG. 6. Here, it is assumed that the multi-AP communication method is Co-OFDMA, the Coordinator AP is determined to be the AP 111, and the Coordinated APs are determined to be the APs 112 and 113.

In step S702, an infrastructure connection in which multi-AP communication using the Co-OFDMA method is enabled is established between the MFP 100 and the AP 112. The processing performed in step S702 corresponds to the processing performed in steps S603 to S606 of FIG. 6. Note that in step S702, the MFP 100 notifies the AP 112 that the MFP 100 can connect using Co-OFDMA. This notification is made using a Probe Request frame or an Association Request frame, for example.

In step S703, the AP 111, the AP 112, the AP 113, and the MFP 100 adjust the operating parameters for Co-OFDMA under the control of the AP 111. The processing performed in step S703 corresponds to the processing performed in step S608 of FIG. 6. For example, the frequency band with the connection destination AP of the STA is adjusted, the RU and transmission timing used when transmitting data from each AP are adjusted, the RU and transmission timing used when transmitting data from the STA are adjusted, and the like.

In step S704, data is exchanged between the AP 112 and the MFP 100, and between the AP 113 and the MFP 100, on the basis of the adjusted RUs and communication timings. The processing performed in step S704 corresponds to the processing performed in step S610 of FIG. 6.

In step S705, the CPU 212 of the MFP 100 determines whether a P2P connection trigger has occurred. If a trigger for a P2P connection is determined to have occurred, the processing of step S706 is executed. The trigger for a P2P connection is, for example, a connection request for the P2P connection being received from the mobile terminal device 102, which is the connection partner in the P2P connection, when a P2P connection is enabled in the MFP 100. The P2P connection trigger is, for example, that the MFP 100 has accepted an operation instructing a P2P connection with the mobile terminal device 102 as the connection partner. However, the trigger is not limited thereto. For example, the P2P connection trigger may be that a P2P connection has been enabled in the MFP 100. In this case, when the P2P connection is enabled, the processing of step S706 is executed before receiving the connection request for the P2P connection, accepting an operation instructing a P2P connection with the mobile terminal device 102 as a connection partner, and the like. For example, when the “Wireless Direct” item in FIG. 3B is selected and an operation to change the setting from “Disabled” to “Enabled” is accepted, a P2P connection is enabled. In addition, if the MFP 100 is turned on while the “Wireless Direct” item is set to “Enabled”, the P2P connection is enabled. When the P2P connection is enabled, a beacon (wireless signal) indicating that a P2P connection can be established is transmitted from the MFP 100, and the MFP 100 can be discovered as a target for the P2P connection from among the surrounding devices. When an operation instructing a P2P connection with the MFP 100 as a connection partner is made in the mobile terminal device 102 that has received a beacon indicating that a P2P connection with the MFP 100 can be established, a connection request for a P2P connection is transmitted from the mobile terminal device 102 to the MFP 100. In addition, even if no operation instructing a P2P connection with the MFP 100 as a connection partner is made in the mobile terminal device 102, there are cases where P2P communication is enabled in the mobile terminal device 102. In such a case, a connection request for a P2P connection can be transmitted from the MFP 100 to the mobile terminal device 102 by the MFP 100 receiving a beacon emitted by the mobile terminal device 102. In this case, a connection request for the P2P connection is transmitted from the MFP 100 to the mobile terminal device 102 in response to an operation instructing the P2P connection with the mobile terminal device 102, which is the connection partner for the P2P connection, being accepted in the MFP 100.

In step S706, the CPU 212 of the MFP 100 executes P2P connection processing with the mobile terminal device 102. For example, connection processing using Wi-Fi Direct is executed. In this case, Wi-Fi Direct connection processing between the MFP 100 and the mobile terminal device 102 is executed such that the MFP 100 becomes the Group Owner. The connection processing in step S706 is executed through a method that does not use OFDMA.

In step S707, the CPU 212 of the MFP 100 requests the AP 112 to terminate the infrastructure connection. Specifically, the CPU 212 transmits a De-authentication frame and requests the connection made using Co-OFDMA to be terminated (cut off). Note that the request is not limited to a request transmitted to the AP 112, and may be transmitted to any of the plurality of APs constituting the multi-AP group. In other words, the request may be transmitted to the AP 113, for example.

In step S708, the CPU 212 of the MFP 100 performs control to reestablish an infrastructure connection with the AP 112 using a method other than Co-OFDMA. This control is performed automatically after step S705, even if no operation for establishing an infrastructure connection has been made by the user. For example, the CPU 212 transmits a Probe Request frame or an Association Request frame including information indicating that Co-OFDMA is not supported to the AP 112 that is the connection partner reestablishing the infrastructure connection. The CPU 212 then performs control to establish the connection after notifying the AP 112 that Co-OFDMA is not supported. Alternatively, the CPU 212 performs control to establish the connection after notifying the AP 112 that the MFP 100 does not support Co-OFDMA by not transmitting a specific frame specified by IEEE 802.11bn to the AP 112. When an infrastructure connection is established using a method other than Co-OFDMA, the MFP 100 connects to the AP 112 using a method that does not support multi-AP communication, or a method that does support multi-AP communication but is not Co-OFDMA (e.g., Joint-TX). Although the connection partner of the MFP 100 in step S707 has been described as being the AP 112, the configuration is not limited thereto, and another AP may be used as long as that AP is on the same network as the AP connected in step S702. This is because an AP on the same network can perform communication with the same communication partner (e.g., the mobile terminal device 101) that was able to perform communication over the infrastructure connection while connected in step S702. An AP on the same network is, for example, an AP that belongs to the same multi-AP group 110 as the AP 112 (e.g., the AP 113). Note that if it is not necessary to be able to perform communication with the same communication partner that was able to perform communication over the infrastructure connection while connected in step S702 (e.g., the mobile terminal device 101), an AP on the other network may be connected. For example, at the time when step S707 is performed, a connection may be made with the AP having the best radio wave conditions among the APs with which connections can be made. Such processing enables the MFP 100 to perform communication without being limited by the adjustment to the operating parameters made under the control of the AP 111 in step S703.

The MFP 100 according to the present embodiment switches between infrastructure mode and P2P mode through time-division in the operation of the antenna and analog front end. This switching takes particularly long when switching between widely-separated frequency bands, such as when the frequency band is 2.4 GHz on the infrastructure connection side and 5 GHz on the P2P connection side, for example. In addition, Co-OFDMA requires the use of a complex method in modulation processing to keep the frequency band used when transmitting data within a narrow range, which consumes significant computational resources of the CPU of the wireless unit 250. Therefore, due to the overhead required to switch between the wireless communication on the P2P connection side and the wireless communication on the infrastructure connection side, and the communication processing load on the infrastructure connection side, switching to wireless communication on the P2P connection side may not be easy. This results in a drop in the communication efficiency on the P2P connection side.

In the present embodiment, the connection method on the infrastructure connection side is changed to a method other than Co-OFDMA. Such processing enables an infrastructure connection to be established with the AP, regardless of schedule adjustments by the Coordinator AP, through connection parameters that make it easy to switch with the P2P connection side.

When performing wireless communication on the P2P connection side within the designated frequency band designated by the Coordinator AP, it is necessary for the P2P connection side to wait for data transmission and reception, even though the infrastructure connection side is not actually transmitting or receiving data.

In the present embodiment, the connection method on the infrastructure connection side is changed to a method other than Co-OFDMA. Such processing eliminates the need for the P2P connection side to wait for data transmission and reception, which suppresses drops in the communication efficiency on the P2P connection side.

The foregoing describes that after step S705, following the establishment of the P2P connection in step S706, a connection is established again using a non-Co-OFDMA method on the infrastructure connection side in steps S707 and S708. However, the processing is not limited thereto, and the processing of steps S707 and S708 may be executed after S705, and the processing of step S706 may be executed thereafter.

The aforementioned step S705 is processing for determining whether an event that serves as a trigger for performing the processing of steps S707 and S708 has occurred. Specifically, the following determinations are made, for example.

(A) A determination as to whether a connection request for a P2P connection has been received from the mobile terminal device 102, which is the connection partner for the P2P connection, while the P2P connection is enabled. Alternatively, a determination as to whether the MFP 100 has accepted an operation instructing a P2P connection with the mobile terminal device 102 as the connection partner. In other words, this is a determination as to whether a trigger for starting connection processing with the connection partner in a P2P connection has occurred. Factors for starting the connection processing include, for example, receiving an Association Request or transmitting an Association Response.

When executing the processing of steps S707 and S708 in response to the determination in (A) being true, the infrastructure-side reconnection processing using the non-Co-OFDMA method in steps S707 and S708 is not performed until an actual P2P connection is established, even after the P2P connection has been enabled. Accordingly, even after the P2P connection is enabled, wireless communication on the infrastructure connection side using multi-AP communication in Co-OFDMA can be performed until the actual P2P connection is established.

(B) A determination that P2P connections are enabled in the MFP 100. In other words, this is a determination as to whether a trigger for starting the transmission of a Beacon frame has occurred.

When executing the processing of steps S707 and S708 in response to the determination in (B) being true, the infrastructure connection side can be set to a non-Co-OFDMA method before the P2P connection is established. Accordingly, P2P mode wireless communication can be executed more efficiently when accepting connection requests for P2P connections, or when establishing P2P connections.

In addition, the following determination may be executed in step S705.

(C) A determination as to whether communication that transmits or receives a predetermined type of data (e.g., print data), or communication that exceeds a predetermined amount of communication traffic, has been started on the P2P connection side after the P2P connection is established.

If the result of the determination in (C) is true, processing may be performed for reconnecting using the non-Co-OFDMA method on the infrastructure connection side in steps S707 and S708.

In addition, even if the results of the determinations (A) to (C) are true, if the following condition is met, control may be performed so that the processing for reconnecting using the non-Co-OFDMA method on the infrastructure connection side in steps S707 and S708 is not executed. When the following condition is not met, e.g., when the following specific communication processing has ended, the processing for reconnecting using the non-Co-OFDMA method on the infrastructure connection side in steps S707 and S708 may be executed.

(Condition) That communication processing for transmitting and receiving specific data using Co-OFDMA on the infrastructure connection side (e.g., transmitting and receiving print data and scan data to and from the mobile terminal device 101 via the AP, and transmitting and receiving data for updating the firmware of the MFP) is in progress.

Note that in the reconnection processing in step S708, the AP may be requested to establish an infrastructure connection using the same channel as the channel used in the P2P connection, and may be controlled to establish the infrastructure connection using the same channel as the channel used in the P2P connection. This makes it possible to reduce the overhead when switching between P2P mode and infrastructure mode through time-division.

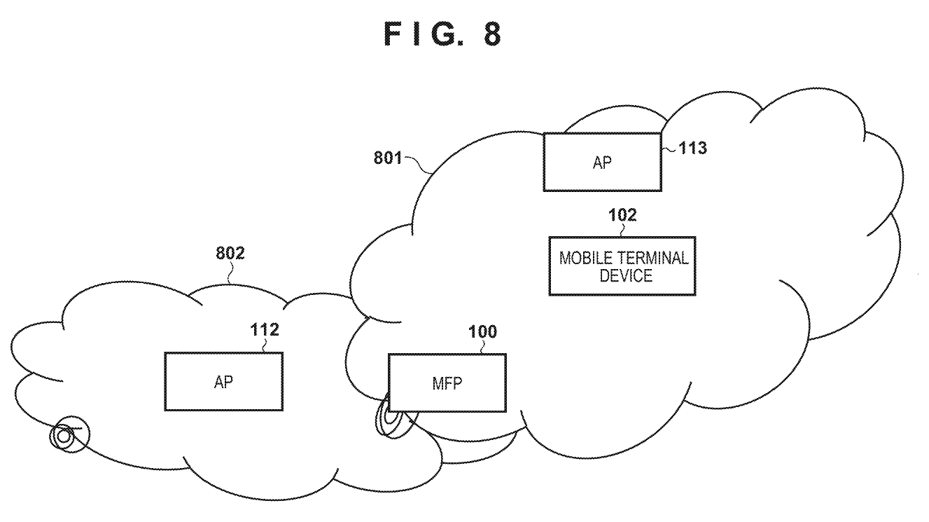

Alternatively, in the reconnection processing in step S708, the AP may be requested to establish an infrastructure connection using a frequency band (RU or communication channel) that does not interfere with the frequency band used on the P2P connection side. This makes it possible to suppress interference between the wireless communication on the P2P connection side and the wireless communication on the infrastructure connection side. This will be described in detail with reference to FIG. 8.

FIG. 8 is a diagram illustrating how what is known as the “hidden node problem” occurs when the MFP 100 starts performing communication with the AP 112 in step S704.

When the AP 113 transmits a carrier wave in the communication between the MFP 100 and the AP 113, a device within a wireless communication range 801 can detect carrier waves from the AP 113 through carrier sensing. Here, the MFP 100 and the mobile terminal device 102 can detect the carrier waves from the AP 113. Accordingly, the mobile terminal device 102 can start outputting its own carrier waves after the carrier waves from the AP 113 stop, and because the carrier waves from the mobile terminal device 102 and the carrier waves from the AP 113 do not collide, a drop in communication efficiency caused by such collisions does not occur.

However, when communication between the MFP 100 and the AP 112 starts in step S704, the AP 112 cannot detect the carrier waves from the mobile terminal device 102, and thus the AP 112 may transmit its own carrier waves while the carrier waves from the mobile terminal device 102 are being transmitted. The carrier waves from the AP 112 can be received by a device within a wireless communication range 802, and the carrier waves from the mobile terminal device 102 and the carrier waves from the AP 112 collide at the position of the MFP 100, where the wireless communication range 801 and the wireless communication range 802 overlap. In the event of such a collision, the MFP 100 cannot receive the communication from the mobile terminal device 102 or from the AP 112 correctly, making retransmission from both the mobile terminal device 102 and the AP 112 necessary and reducing the communication efficiency. A system for Request To Send (RTS)/Clear To Send (CTS), specified in IEEE 802.11, exists as a measure against the hidden node problem. However, when using RTS/CTS, communication latency occurs and the communication efficiency drops; furthermore, collisions between the wireless communication on the infrastructure connection side and the wireless communication on the P2P connection side, which are different BSSs to begin with, cannot be handled by RTS/CTS. Therefore, this problem cannot be solved by RTS/CTS.

However, in the present embodiment, the connection method on the infrastructure connection side is changed to a method other than Co-OFDMA. Accordingly, in addition to the effects of the present embodiment described above, a drop in communication efficiency caused by the hidden node problem can be avoided.

### Processing when Starting Infrastructure Connection Using Co-OFDMA during P2P Connection

Processing performed when the MFP 100 starts an infrastructure connection with an AP constituting a multi-AP group using Co-OFDMA during a P2P connection will be described next. When starting an infrastructure connection with an AP constituting a multi-AP group using Co-OFDMA during a P2P connection and performing multi-AP communication, the wireless communication on the infrastructure connection side and the wireless communication on the P2P connection side may interfere with each other, which reduces the communication efficiency. In particular, this may hinder efficient communication using multi-AP communication, potentially preventing the full benefits of multi-AP communication from being realized. Accordingly, in the present embodiment, when the MFP 100 establishes an infrastructure connection with an AP constituting a multi-AP group using Co-OFDMA during a P2P connection, the MFP 100 prompts the P2P connection to be terminated or automatically terminates the P2P connection.

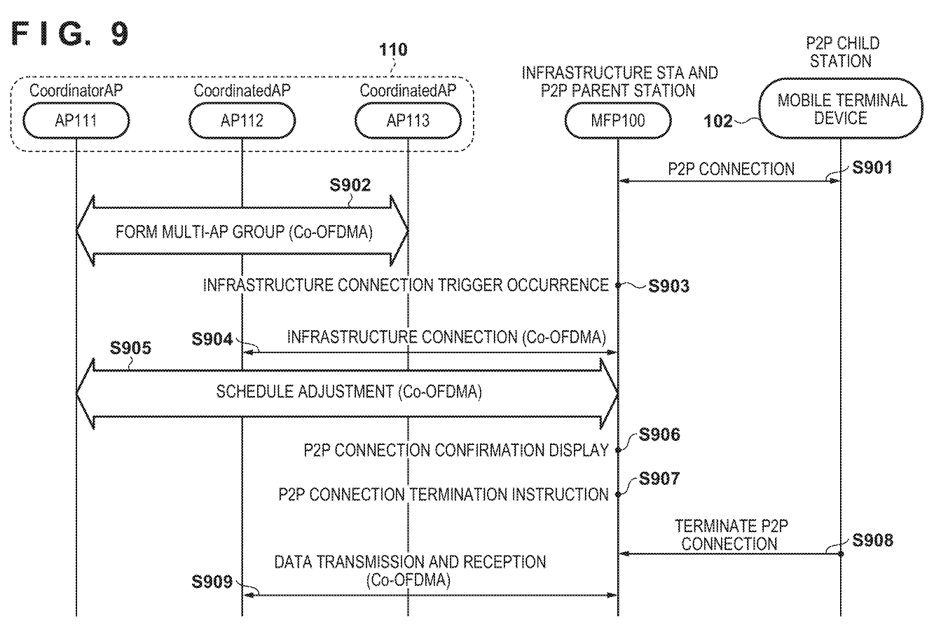

FIG. 9 is a diagram illustrating a sequence performed when an infrastructure connection, in which Co-OFDMA multi-AP communication is enabled, is established after the MFP 100 establishes a wireless LAN P2P connection with the mobile terminal device 102. Processing executed by each device in this sequence is implemented by the CPU of each device reading out various programs stored in a memory provided in that device, such as a ROM or the like, into a RAM and executing those programs. Here, the mobile terminal device 102 is a device that performs communication with the MFP 100 through a P2P connection, and is not a device that performs communication with the MFP 100 via an AP (over an infrastructure connection). As such, the mobile terminal device 102 is given a different reference sign, being a device different from the mobile terminal device 101 in FIG. 1, which is a device that performs communication with the MFP 100 via an AP (over an infrastructure connection). However, the configuration of the mobile terminal device 102 is assumed to be the same as that of the mobile terminal device 101 illustrated in FIGS. 4A and 4B.

In step S901, the CPU 212 of the MFP 100 establishes a P2P connection with the mobile terminal device 102. The P2P connection in step S901 is established using a method other than OFDMA. Specifically, for example, the MFP 100 serves as the Wi-Fi Direct Group Owner, and a Wi-Fi Direct connection is established with the mobile terminal device 102.

In step S902, the AP 111, the AP 112, and the AP 113 form the multi-AP group 110 through Co-OFDMA. This processing corresponds to steps S601 and S602 of FIG. 6. In step S902, it is assumed that the multi-AP communication method is Co-OFDMA, the AP 111 is determined as the Coordinator AP, and the APs 112 and 113 are determined as the Coordinated APs.

In step S903, the CPU 212 of the MFP 100 determines whether a trigger has occurred for establishing an infrastructure connection in which Co-OFDMA multi-AP communication has been enabled. The processing of step S904 is executed when the trigger is determined to have occurred. However, the processing from step S904 onward is not executed when the trigger is determined not to have occurred. The trigger for establishing an infrastructure connection in which Co-OFDMA multi-AP communication is enabled is, for example, one of the following:

The setting state of the “Enable/Disable Wireless LAN Settings” item included in the wireless LAN settings menu in FIG. 3C has been changed from “disabled” to “enabled” while the connection information for the connection to the Coordinated AP belonging to the multi-AP group that performs Co-OFDMA multi-AP communication is saved in the MFP 100. Note that the connection information for the connection to the Coordinated AP is, for example, an SSID and a password.

The power is turned on while the setting state of the “Enable/Disable Wireless LAN Settings” item included in the wireless LAN settings menu in FIG. 3C is enabled, and the connection information for the connection to the Coordinated AP belonging to the multi-AP group that performs Co-OFDMA multi-AP communication is saved in the MFP 100.

The setting state of the “Enable/Disable Wireless LAN Settings” item included in the wireless LAN settings menu in FIG. 3C is enabled, and the MFP 100 moves from a range where the radio waves from the Coordinated AP cannot be received into a range where such radio waves can be received while the connection information for the connection to the Coordinated AP belonging to the multi-AP group that performs Co-OFDMA multi-AP communication is saved in the MFP 100.

After the “Wireless LAN Setup” item included in the wireless LAN settings menu in FIG. 3C is selected, an operation instructing a wireless LAN connection to be made with a communication partner, namely, the Coordinated AP belonging to the multi-AP group that performs Co-OFDMA multi-AP communication, is performed through a method corresponding to any of the items in the Wireless LAN Setup in FIG. 3D.

In step S904, the CPU 212 of the MFP 100 establishes an infrastructure connection in which Co-OFDMA multi-AP communication is enabled with the AP 112. This processing corresponds to steps S603 to S606 of FIG. 6. Note that in step S904, the MFP 100 notifies the AP 112 that the MFP 100 can connect using Co-OFDMA. This notification is made using a Probe Request frame or an Association Request frame, for example.

In step S905, the AP 111, the AP 112, the AP 113, and the MFP 100 adjust the operating parameters for Co-OFDMA under the control of the AP 111. This processing corresponds to step S608 of FIG. 6. For example, the operating parameters of Co-OFDMA are adjusted by adjusting the frequency band with the connection destination AP for the STA, adjusting the RU and transmission timing when transmitting data from each AP, adjusting the RU and transmission timing when transmitting data from the STA, and the like.

In step S906, the CPU 212 of the MFP 100 displays a confirmation dialog screen (a confirmation screen) in the console unit 220.

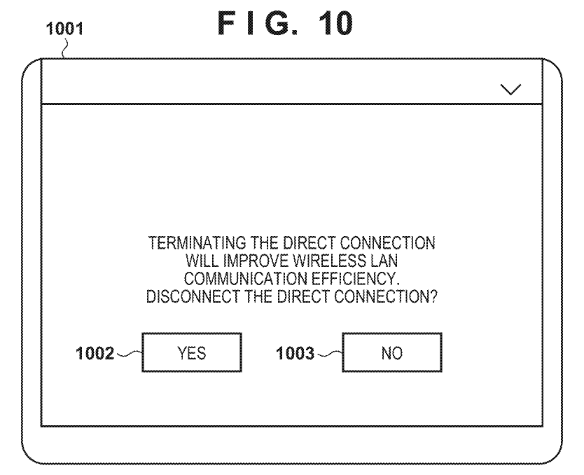

FIG. 10 is a diagram illustrating an example of the confirmation dialog screen displayed in S906. A message reading “Terminating the direct connection will improve wireless LAN communication efficiency. Terminate the direct connection?” is displayed in a confirmation dialog screen 1001. In the present embodiment, terminating the P2P connection prevents wireless communication on the infrastructure connection side and wireless communication on the P2P connection side from interfering with each other and inhibiting efficient communication using multi-AP communication. Accordingly, in step S906, the P2P connection currently established is prompted to be terminated by displaying the confirmation dialog screen. A “Yes” button 1002 for accepting an instruction to terminate the P2P connection and a “No” button 1003 for accepting an instruction to maintain (i.e., not terminate) the P2P connection are provided in the confirmation dialog screen 1001.

In step S907, the CPU 212 of the MFP 100 determines whether the “Yes” button 1002 for accepting the instruction to terminate the P2P connection, or the “No” button 1003, has been selected. The processing of step S908 is executed when the “Yes” button 1002 is determined to have been selected. On the other hand, the processing from step S908 onward is not executed, and the P2P connection is maintained without being terminated, when the “No” button 1003 is determined to have been selected.

In step S908, the CPU 212 of the MFP 100 performs control to terminate the P2P connection with the mobile terminal device 102. Specifically, for example, the CPU 212 transmits a De-authentication frame to the mobile terminal device 102 and terminates the Wi-Fi Direct connection.

In step S909, the CPU 212 of the MFP 100 executes data transmission and reception between the AP 112 and the AP 113 on the basis of the operating parameters adjusted in step S905, e.g., the RU and communication timing. This processing corresponds to step S610 of FIG. 6.

According to the processing of FIG. 9, in step S906, the confirmation dialog screen prompting the P2P connection to be terminated is displayed on the basis of a trigger for establishing an infrastructure connection in which Co-OFDMA multi-AP communication has been enabled having occurred in step S903. When an instruction to terminate the P2P connection is accepted in the confirmation dialog screen, the P2P connection is terminated. Such a configuration makes it possible to realize the full benefits of Co-OFDMA multi-AP communication without producing interference with the wireless communication on the P2P connection side. Furthermore, according to the processing illustrated in FIG. 9, the hidden node problem described with reference to FIG. 8 can be suppressed.

Note that in step S908, rather than terminating the P2P connection, the CPU 212 of the MFP 100 may change the communication ratio such that the communication ratio of the wireless communication on the infrastructure connection side is higher than the communication ratio on the P2P connection side.

In addition, other processing may be performed when a trigger for establishing an infrastructure connection in which Co-OFDMA multi-AP communication has been enabled occurs in step S903 and an infrastructure connection in which Co-OFDMA multi-AP communication has been enabled is established. For example, in such a case, the P2P connection may be terminated in step S908 without executing the processing of steps S906 and S907. In other words, the P2P connection may be terminated automatically without an instruction being accepted from the user to terminate the P2P connection. Additionally, for example, the CPU 212 of the MFP 100 may determine the amount of communication traffic in the wireless communication on the P2P connection side, execute the processing of step S906 when the amount of traffic is less than a predetermined amount, and execute the processing of steps S906 to S908 when the amount of traffic is high (i.e., at least the predetermined amount). In that case, the CPU 212 may control the processing of steps S906 to S908 to be performed if, after the infrastructure connection in which the Co-OFDMA multi-AP communication is enabled has been established, the amount of traffic in the wireless communication on the P2P connection side has dropped below the predetermined amount.

In addition, the configuration for performing the processing of steps S906 to S908 when a trigger for establishing an infrastructure connection in which Co-OFDMA multi-AP communication is enabled has been determined to have occurred in step S903 is not limited to the sequence illustrated in FIG. 9. For example, the processing of steps S906 to S908 may be performed when starting the transmission and reception of data that meets a predetermined condition at the point in time when, in a state where an infrastructure connection is established, the transmission and reception of data meeting the predetermined condition is recognized on the infrastructure connection side. Recognizing the transmission and reception of data corresponds to a job being detected, for example. Here, the transmission and reception of data meeting the predetermined condition corresponds to the transmission and reception of at least a predetermined volume of data, for example. Alternatively, the transmission and reception of data meeting the predetermined condition corresponds to the transmission and reception of a predetermined type of data, for example. This is, specifically, the transmission and reception of print data and scan data to and from the mobile terminal device 101 via an AP, and the transmission and reception of data for updating the firmware of the MFP 100, for example.

Note that in the present embodiment, the processing described with respect to multi-AP communication Co-OFDMA may be applied to IEEE 802.11ax OFDMA (Wi-Fi 6). In other words, if a P2P connection is started when the MFP 100 is in an infrastructure connection with an external AP and communication using IEEE 802.11ax OFDMA is possible, control may be performed to terminate the infrastructure connection over which communication using IEEE 802.11ax OFDMA is possible once, and then re-establish the infrastructure connection using a method not supported by IEEE 802.11ax OFDMA, as illustrated in FIG. 7. Additionally, when starting an infrastructure connection using IEEE 802.11ax OFDMA while a P2P connection is established, control may be performed to prompt the user to terminate the P2P connection or automatically terminate the P2P connection, as illustrated in FIG. 9. In other words, the various instances of control may be performed having replaced the multi-AP communication Co-OFDMA according to the present embodiment with IEEE 802.11ax OFDMA. The same effects as those described in the present embodiment can be achieved in such a case as well.

The above-described various types of control performed by the CPUs of the respective devices may be performed by a single piece of hardware, or the control of the apparatus as a whole may be performed by dividing the processing up among multiple pieces of hardware (e.g., multiple processors or circuits).

Although the foregoing has described the present disclosure in detail on the basis of preferred embodiments thereof, the present disclosure is not intended to be limited to the specific embodiments, and all variations that do not depart from the spirit of the present disclosure are intended to be included in the scope of the present disclosure. Furthermore, the above-described embodiments are merely embodiments of the present disclosure, and different embodiments can be combined as appropriate.

Although the foregoing embodiments describe cases where the present disclosure is applied to an MFP as examples, the present disclosure is not limited to this example, and can be applied in any wireless device capable of multi-AP communication. In other words, the present disclosure can be applied in personal computers, PDAs, tablet terminals, mobile telephone terminals such as smartphones, music players, game consoles, e-book readers, smart watches, various measurement devices (sensor devices) such as thermometers and hygrometers, and the like. The present disclosure can also be applied in digital cameras (including still cameras, video cameras, network cameras, and security cameras), printers, scanners, and drones. The present disclosure can also be applied in video output devices, audio output devices (e.g., smart speakers), streaming media players, wireless LAN client devices (adapters) to which USB terminals, LAN cable terminals, or the like can be connected, and the like. Video output devices include, for example, a device such as a set-top box, which obtains (downloads) a moving image or still image on the Internet, specified by a URL provided by a communication apparatus, and outputs the moving image or still image to a display device connected through a video output terminal such as an HDMI (registered trademark) terminal. Through this, streaming playback, a mirrored display (a display in which content displayed in a communication apparatus is also displayed on a display device), or the like is implemented in a display device. The video output device also includes a media player such as a television, a hard disk recorder, a Blu-ray recorder, a DVD recorder, or the like, as well as a head-mounted display, a projector, a television, a display device (monitor), a signage device, or the like. The present disclosure can also be applied in a device capable of connecting through Wi-Fi, or what is known as a “smart home appliance”, such as an air conditioner, a refrigerator, a washing machine, a vacuum cleaner, an oven, a microwave oven, a lighting fixture, a heating appliance, a cooling appliance, or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-233112, filed December 27, 2024 which is hereby incorporated by reference herein in its entirety.

What is claimed is:

1. A communication apparatus comprising:
at least one memory and at least one processor which function as:
a first communication unit configured to perform communication via an external access point through wireless LAN communication;
a second communication unit configured to perform communication directly with an external terminal device through wireless LAN communication, without going through the external access point; and
a control unit configured to perform control such that, in a state where a connection has been established by the second communication unit with the external terminal device, when a connection is to be established by the first communication unit with the external access point in which communication through a first communication method performed via a plurality of external access points is enabled, specific processing for terminating the connection established by the second communication unit with the external terminal device is performed.

2. The communication apparatus according to claim 1,
wherein the control unit is configured to perform control such that, even when a connection is to be established with the external access point in which communication through the first communication method is enabled, the specific processing is not performed if an amount of communication performed by the second communication unit is a predetermined amount or more.

3. The communication apparatus according to claim 2,
wherein the control unit is configured to perform control such that, after a connection is established with the external access point in which communication through the first communication method is enabled, the specific processing is performed in response to the amount of communication performed by the second communication unit falling below the predetermined amount.

4. The communication apparatus according to claim 1,
wherein the first communication method is a communication method in which each of a plurality of access points belonging to a group including the external access point with which a connection is to be established by the first communication unit performs communication with the communication apparatus using a different resource unit.

5. The communication apparatus according to claim 1,
wherein the first communication method is Coordinated-Orthogonal Frequency Division Multiple Access (Co-OFDMA) in multi-AP communication compliant with an IEEE 802.11 series standard.

6. The communication apparatus according to claim 1,
wherein the specific processing is processing including displaying a screen that accepts, from a user, an instruction to terminate the connection established with the external terminal device by the second communication unit, and
the control unit performs control such that the connection established with the external terminal device by the second communication unit is terminated in a case where the instruction is accepted while the screen is displayed.

7. The communication apparatus according to claim 1,
wherein the specific processing is processing including terminating the connection established with the external terminal device by the second communication unit even in a case where an instruction to terminate the connection established with the external terminal device by the second communication unit is not accepted from a user.

8. The communication apparatus according to claim 1,
wherein in a first state where a connection with the external access point was established by the first communication unit and communication through the first communication method is possible, if predetermined communication is to be started by the second communication unit, the control unit performs control to change to a second state in which the first communication unit is capable of performing communication with the external access point through a communication method different from the first communication method.

9. A communication apparatus comprising:
at least one memory and at least one processor which function as:
a first communication unit configured to perform communication via an external access point through wireless LAN communication;
a second communication unit configured to perform communication directly with an external terminal device through wireless LAN communication, without going through the external access point; and
a control unit configured to perform control such that, in a state where a connection has been established by the second communication unit with the external terminal device and furthermore a connection has been established by the first communication unit with the external access point in which communication through a first communication method performed via a plurality of external access points is enabled, when transmission or reception of data meeting a predetermined condition is to be started using a first communication method, specific processing for terminating the connection established by the second communication unit with the external terminal device is performed.

10. The communication apparatus according to claim 9,
wherein the predetermined condition is at least one of a plurality of conditions including:
transmitting or receiving a predetermined volume of data or more, and
transmitting or receiving data of a predetermined type.

11. The communication apparatus according to claim 9,
wherein the first communication method is a communication method in which each of a plurality of access points belonging to a group including the external access point with which a connection is to be established by the first communication unit performs communication with the communication apparatus using a different resource unit.

12. The communication apparatus according to claim 9,
wherein the first communication method is Coordinated-Orthogonal Frequency Division Multiple Access (Co-OFDMA) in multi-AP communication compliant with an IEEE 802.11 series standard.

13. The communication apparatus according to claim 9,
wherein the specific processing is processing including displaying a screen that accepts, from a user, an instruction to terminate the connection established with the external terminal device by the second communication unit, and
the control unit performs control such that the connection established with the external terminal device by the second communication unit is terminated in a case where the instruction is accepted while the screen is displayed.

14. The communication apparatus according to claim 9,
wherein the specific processing is processing including terminating the connection established with the external terminal device by the second communication unit even in a case where an instruction to terminate the connection established with the external terminal device by the second communication unit is not accepted from a user.

15. The communication apparatus according to claim 9,
wherein in a first state where a connection with the external access point was established by the first communication unit and communication through the first communication method is possible, if predetermined communication is to be started by the second communication unit, the control unit performs control to change to a second state in which the first communication unit is capable of performing communication with the external access point through a communication method different from the first communication method.

16. A method executed by a communication apparatus, the method comprising:
performing communication via an external access point through wireless LAN communication;
performing communication directly with an external terminal device through wireless LAN communication, without going through the external access point; and
performing control such that, in a state where a connection has been established with the external terminal device in direct communication performed with the external terminal device without going through the external access point, in communication performed via the external access point, when a connection is to be established with the external access point in which communication through a first communication method performed via a plurality of external access points is enabled, specific processing is performed to terminate the connection established with the external terminal device in direct communication performed with the external terminal device without going through the external access point.

17. A method executed by a communication apparatus, the method comprising:
performing communication via an external access point through wireless LAN communication;
performing communication directly with an external terminal device through wireless LAN communication, without going through the external access point; and
performing control such that, in a state where (i) a connection has been established with the external terminal device in direct communication performed with the external terminal device without going through the external access point, and furthermore (ii) in communication performed via the external access point, a connection has been established with the external access point in which communication through a first communication method performed via a plurality of external access points is enabled, when transmission or reception of data meeting a predetermined condition is to be started using a first communication method, specific processing is performed to terminate the connection established with the external terminal device in direct communication performed with the external terminal device without going through the external access point.

18. A non-transitory computer-readable storage medium storing a program configured to cause a computer to function to:
perform communication via an external access point through wireless LAN communication;
perform communication directly with an external terminal device through wireless LAN communication, without going through the external access point; and
perform control such that, in a state where a connection has been established with the external terminal device in direct communication performed with the external terminal device without going through the external access point, in communication performed via the external access point, when a connection is to be established with the external access point in which communication through a first communication method performed via a plurality of external access points is enabled, specific processing is performed to terminate the connection established with the external terminal device in direct communication performed with the external terminal device without going through the external access point.

19. A non-transitory computer-readable storage medium storing a program configured to cause a computer to function to:
perform communication via an external access point through wireless LAN communication;
perform communication directly with an external terminal device through wireless LAN communication, without going through the external access point; and
perform control such that, in a state where (i) a connection has been established with the external terminal device in direct communication performed with the external terminal device without going through the external access point, and furthermore (ii) in communication performed via the external access point, a connection has been established with the external access point in which communication through a first communication method performed via a plurality of external access points is enabled, when transmission or reception of data meeting a predetermined condition is to be started using a first communication method, specific processing is performed to terminate the connection established with the external terminal device in direct communication performed with the external terminal device without going through the external access point.
